(19) United States
(12) Patent Application Publication
(10) Pub. No.: US 2022/0355725 A1
(43) Pub. Date: Nov. 10, 2022

(54) Method and System for Simulating Propagation of a Composite Electromagnetic Beam

(71) Applicant: Ansys, Inc., Canonsburg, PA (US)

(72) Inventors: Pengyuan Lu, Canonsburg, PA (US); Stefan Thoene, Canonsburg, PA (US); Andreas Steghafner, Canonsburg, PA (US); Josselin Petit, Canonsburg, PA (US)

(21) Appl. No.: 17/458,760

(22) Filed: Aug. 27, 2021

(30) Foreign Application Priority Data
May 4, 2021 (DE) 102021111501.9

(51) Int. Cl. B60Q 1/08; B60Q 1/14

(52) U.S. Cl. CPC B60Q 1/085; B60Q 1/1423; B60Q 2300/00

(57) ABSTRACT

A system for simulation of a composite beam is disclosed. The system can comprise a memory storing executable instructions and one or more processors coupled to the memory to execute the executable instructions. The one or more processors can be configured to generate a representation of the original beam pattern transmitted via a propagation of the composite beam, to invoke a propagation model that represents a distortion for the propagation of the composite beam, and to determine a representation of a distorted beam pattern based on the propagation model and on the representation of the original beam pattern transmitted via the propagation.

### CROSS-REFERENCE TO RELATED APPLICATIONS

This application claims priority to German Patent Application DE 10 2021 111 501.9, filed May 4, 2021, entitled “Device for Simulation of a Propagation of a Composite Electromagnetic Beam and Method to Generate a Model Therefore,” which is incorporated herein by reference in its entirety.

### TECHNICAL FIELD

The field of this disclosure relates to simulation of a composite electromagnetic beam. Specifically, the disclosure relates to devices and methods for generation of models for simulation of a composite electromagnetic beam.

### BACKGROUND

In new generations of headlamps for vehicles, a beam of light can be shaped more or less freely, especially to maximize an illuminated area while avoiding glare for oncoming drivers. One embodiment of such a headlight consists of a light source that provides a beam to a micro-mirror-system. The micro-mirror-system comprises individually controllable mirrors. These mirrors can be controlled such that a composite headlight beam is formed with a desired pattern. The composite headlight beam is further focused on a projection target, e.g. the street by a lens system. In order to specify requirements for these kind of headlights and also in order to study the distortion of the beam pattern and its reflection on the road, the propagation of a composite light beam can be simulated in a computer. A full simulation of such a composite light beam is resource-intensive and can take up to several days. This is too slow for many applications Existing solutions to simulate full pixel beam headlights by masking the desired areas with black rectangles in order to create a desired beam pattern do not account for geometric distortions of the beam pattern nor for chromatic aberrations or intensity changes that are caused by the propagation channel. The result is not a realistic impression. Improvements for these kinds of simulations are desirable, not only for simulations of automotive headlights but for all systems in which a composite electromagnetic beam can be applied.

### DESCRIPTION

A problem is how to improve a simulation of a propagation of an electromagnetic beam.

This problem is solved by the disclosed embodiments, which are in particular defined by the subject matter of the independent claims. The dependent claims provide further embodiments. In the following, different aspects and embodiments of these aspects are disclosed, which provide additional features and advantages.

Some embodiments solve the specific problem to provide a real-time capable simulation for a pixel beam headlight of an automotive vehicle. A pixel beam headlight provides a composite light beam. Each pixel can generate an elementary beam and all beams together form the composite beam. The form of the light beam can be configured by individually activating or deactivating certain pixels, similar to a TV-display. The elementary beams (or pixel beams) and therefore also the composite beam are distorted when they propagate through the components of the pixel beam headlight. In order to model the propagation of the composite beam through the pixel beam headlight, the beam is measured after it exited the pixel beam headlight. A model, which can be evaluated in real-time, and which describes the geometric distortions and chromatic aberrations sufficiently, is then fitted to the measurement data. With this model the distortions of different patterns of a composite light beam can be simulated. This is done by simulating only the representations of the activated pixels necessary for a desired pattern. The propagation model is applied only to each activated elementary beam and the result is integrated to obtain the distorted composite beam.

In the remainder, further aspects and embodiments of these aspects are disclosed.

A first aspect relates to a device, configured to:
receive an original pattern for a composite electromagnetic beam;
provide a representation of the original pattern to be transmitted via the composite electromagnetic beam towards a target;
invoke a propagation model that represents the propagation of the electromagnetic beam towards the target;
determine a representation of a distorted pattern of the composite electromagnetic beam based on the propagation model and on the representation of the original pattern.

A device for simulation of a propagation of a composite electromagnetic beam can be a device for simulating any kind of electromagnetic beams. In particular, the simulation device can be configured to simulate a composite light beam. Such a light beam can be emitted for example by a light system of a car, in particular a pixel based headlight system, as introduced above. Additionally or alternatively, the composite electromagnetic beam can be emitted by a medical device, for example by an imaging processing device. Therefore, the composite electromagnetic beam can be an X-ray or an infrared beam. Additionally or alternatively, the composite beam can be emitted by a lithography device, such as an EUV-device for producing semiconductor systems. Therefore, the electromagnetic beam can also be an ultraviolet beam. These are only examples to show that all kinds of electromagnetic beams can be simulated and therefore all kinds of devices can be simulated by the disclosed simulation device.

The device can comprise a software, which can be executed on a hardware. Additionally or alternatively, the device can comprise hardware solutions without additional software, for example based on an FPGA-implementation. The device can also be distributed across different hardware entities that are connected over a network.

A composite electromagnetic beam can be a beam of a composite source with a plurality of elementary beam sources, such as a pixel-based headlight system. A composite electromagnetic beam can take a plurality of patterns. For a composite electromagnetic light beam, a pattern is, for example, what can be seen of the beam if it is reflected at a target or boundary layer. A pattern comprises a geometric shape of the x-y-plane of the beam, when the z-dimension represents the direction of propagation of the beam. For example, the pattern can be formed by a projection or propagation of the beam from a beam source to a target plane. Furthermore, the pattern can comprise an intensity, i.e. an energy, configuration. Additionally or alternatively, a pattern can comprise a color-scheme of the composite electromagnetic beam. For example a geometric pattern of an electromagnetic beam can be a cross, a rectangle, a ring, or a more complex configuration. Additionally or alternatively, a pattern can be formed by a full beam with a predefined fully or a partly opaque area. With a composite beam it is also possible to turn off a certain part, or certain parts of the beam while another part or other parts remain active. A pattern can also be a complex configuration of the composite beam depending on a spatial resolution, an intensity resolution, and on a color resolution of the composite beam source. The composite electromagnetic beam can comprise a plurality of elementary beams that can be turned on and off individually. This will be explained later in more detail.

A reception of an original pattern of a composite beam can comprise a selection from a plurality of patterns the composite electromagnetic beam can take. The selection can be received, for example, via a user interface or other applicable interface mechanisms. This can comprise a reception of one of the above named geometric patterns, intensities and or colors as a complex configuration, for example a checker-board pattern or even a picture.

A provision of a representation of the original pattern to be transmitted towards a target or boundary layer comprises a computer-readable structure that contains parameters for describing the original pattern, for example a frequency, a color, an intensity. By using a computer-readable structure the composite beam can be processed and simulated by the device. The simulation is done by processing the representation of the original pattern with the propagation model. The simulation can additionally comprise further models to model other parts of the propagation of the beam, which are not comprised by the propagation model. For example the propagation model can represent a light system, such as a pixel beam headlight. Another model can represent a misty environment through which the composite beam propagates after it has exited the pixel beam headlight.

The propagation model relates to a predefined part of the propagation path of the electromagnetic beam or of its elementary beams. For example the propagation model can model the device that produces the electromagnetic beam. This can comprise one or more sources for the emission of electromagnetic beams. Additionally or alternatively, the model can comprise one or more lenses of the device that produces the electromagnetic beam. If the device comprises other parts that affect the propagation of the electromagnetic beam, these other parts can also be represented by the propagation model. Additionally, the propagation model can also comprise one or more parts external to the device that produces the electromagnetic beam, but which do also affect the propagation path of the electromagnetic beam. The propagation model can comprise any part of the propagation path between an idealized beam source and a predefined target or boundary layer, wherein the predefined boundary layer can also comprise a boundary layer at infinite distance to the beam source.

The propagation model is—at least partly—independent of a pattern, i.e. the same model can be used for a simulation of different patterns, for example for different geometric patterns, of the electromagnetic beam.

An embodiment of the first aspect relates to a device, wherein the propagation model represents a geometric distortion of the original beam.

In particular a geometrical pattern of the original beam can be represented in the propagation model. For example a rectangle can be used as a geometrical pattern of an original composite beam. By the propagation model, the original composite beam can be mapped to a pattern of a high or low beam of an automotive vehicle, as an intermediate beam pattern. Afterwards, the intermediate beam pattern can be processed by the model to provide for the geometrical distortions of the intermediate beam pattern in order to arrive at a distorted beam pattern. By this, a very flexible simulation can be provided, wherein different beam patterns and propagation paths can be represented by a single model, in order to calculate a geometric distortion of an original and/or intermediate beam pattern.

As already explained, different original beam patterns and/or different intermediate beam patterns can be simulated with the same propagation model.

An embodiment of the first aspect relates to a device, wherein the propagation model represents a chromatic distortion of the original composite beam.

In particular a composite beam can comprise a complex color distribution over its pattern. The propagation model can in particular comprise different sub-models in order to represent a predefined color model. For example, an RGB-color-model can be represented by three different sub-models that represent the geometrical distortions and chromatic distortions for red, green, and blue along a predefined propagation path, e.g. through a pixel beam headlight. The results of the three sub-models are superimposed (e.g. based on color overlay) to obtain the distorted composite electromagnetic beam pattern. Other frequency dependencies for the propagation model can be implemented, as shown in the next embodiment.

An embodiment of the first aspect relates to a device, wherein the propagation model comprises sub-models and wherein each of the sub-models is related to a different frequency of the original composite beam.

A frequency can also be a frequency range, in the sense of this disclosure. Frequency-dependent sub-models can be used not only for visible light. Frequency-dependent sub-models can also be used to model a change of energy, a frequency shift, a phase-shift, and/or a geometric distortions of a beam pattern in the non-visible electromagnetic range along a propagation path towards a target or boundary layer. For example, frequency-dependent sub-models can be used for a simulation of UV-lithography devices used in semiconductor production or for a simulation of IR-sources and respective sensors. Frequency-dependent sub-models can in general be used to achieve a higher accuracy of the beam distortions with respect to the spectrum of the beam. In particular, the sub-models can be executed concurrently in order to improve real-time capability of the simulation.

An embodiment of the first aspect relates to a device, wherein the representation of the distorted pattern depends on the representation of the original pattern.

The propagation model does not need to rely on a sampled subset of information of the original composite beam pattern. The model can be used to process all sample points provided by the representation of the original pattern of the composite beam. Therefore, the model can be used for different patterns of the original composite beam without pattern-dependent adaptations of a sampling scheme. This can be done by applying the propagation model to the representation of all active pixels used to provide a certain pattern of the original composite beam, in order to determine a representation of a distorted beam pattern.

An embodiment of the first aspect relates to a device, wherein a ratio between a size or a sample size of the representation of the original pattern and of the representation of the distorted pattern is:
equal to 1;
smaller than 1; and/or
greater than 1;
   In particular a smaller sample size for the representation of the distorted beam can be used in order to increase real-time capabilities of the device.

An embodiment of the first aspect relates to a device, wherein the sample size of:
the representation of the original pattern,
the representation of the distorted pattern, and/or
the propagation model depends on one or more of the following parameters:
a user input;
a received information;
a wavelength of the original pattern and/or of the distorted pattern;
a temperature in the environment of the composite electromagnetic beam;
the original pattern and/or the distorted pattern itself.

The representation of the original pattern can depend on the total number of pixels provided by an electromagnetic beam system. The representation of the original pattern can alternatively comprise a subset of the pixels, in particular in order to reduce the computation resources needed for computing the representation of the distorted pattern. Additionally or alternatively, a more complex propagation model with a larger sample size can be selected according to the computing power of a hardware used for running the simulation. Additionally or alternatively, for a certain frequency range a sub-model can be used with a larger sampling size than the sampling size of a sub-model that is related to a different frequency range. Furthermore, a temperature of an electromagnetic beam system can affect a distortion of the electromagnetic beam and therefore this parameter can also be an influence on the propagation model. This can also be taken into account for the simulation. Therefore a sample size of the representation of the original beam and/or of the representation of the distorted beam can depend upon a temperature. Furthermore, the simulation can also depend on an external input. An external input can comprise a selection of a new original pattern. An external input can also cause a change of the propagation model, for example a change of the sampling points used by the propagation model. On these sampling points the propagation model can use distortion values from a full simulation and/or from a measurement. Or it can calculate the distorted sampling points based on a full computation. The remaining sampling points of the original pattern can be interpolated, e.g. by a polynomial interpolation.

In order to provide a powerful and adaptable simulation environment, the simulation should be adaptable to different kinds of external and internal parameters.

An embodiment of the first aspect relates to a device, wherein the representation of the original pattern, of the distorted pattern and/or the propagation model are time variant.

The propagation model with any of the parameters explained above can be subject to change or adjusted during the simulation with respect to at least one of these parameters. By such an adjustment, the simulation can be adapted in particular to different events during the simulation. For example, a traffic situation can be simulated wherein a high beam of an automotive vehicle, which is implemented by a pixel beam headlight, can illuminate by a pattern that illuminates a maximum part of the street if no opposing traffic occurs. In the event of an opposing vehicle another pattern of the pixel beam headlight can be selected and therefore the simulation can be accordingly adapted. By implementing the simulation device for time variant beam scenarios, the simulation device can be used to simulate more relevant scenarios and/or more functions of a real-world device to be simulated.

An embodiment of the first aspect relates to a device, wherein the propagation model enables a simulation of the composite electromagnetic beam in real-time.

Real-time can mean that the operation of the simulation device is realized such that the simulation results are available within a predetermined period of time. A simulation result can include a representation of a distorted beam pattern or a representation related thereto, e.g. a failure measure. Additionally or alternatively, simulation data may accrue according to a random distribution over time or at predetermined times. Additionally or alternatively, real time simulation can generate simulate results within a predefined upper time limit. Additionally or alternatively, real-time can mean that a simulation of a device and/or of an activity does not occur with interruptions or unexpected delays, from a user perspective. To achieve real-time simulation the propagation model can have a reduced complexity compared to a physically complete propagation model. This will be explained later.

An embodiment of the first aspect relates to a device, wherein the composite beam is represented by a plurality of beam pixels and wherein the original pattern depends on which of the beam pixels are activated and which are deactivated.

By modelling a composite beam pattern using a plurality of elementary beams a more flexible computation of a distorted beam pattern can be provided. In particular a shape of the composite beam can be modelled using a predefined configuration of different elementary beams or pixel beams, as comprised by the next embodiment.

An embodiment of the first aspect relates to a device, wherein the plurality of pixel beams are sourced from an electromagnetic wave system.

An elementary beam or pixel beam can represent an elementary beam source of a simulated electromagnetic beam system. An elementary electromagnetic beam source can be any device that can convey, reflect, or produce an electromagnetic beam, for example a light bulb, a laser, or one or more mirrors that are configured to reflect light coming from a light source to a target, an X-ray source, an UV-source and/or an IR-source. For example, if a system is an automotive vehicle headlight system that comprises a plurality of elementary light sources (also called pixel beam headlight), an elementary beam can represent an elementary light source or a subset of elementary sources of the automotive headlight system. An elementary electromagnetic beam source can be, for example, a single laser of a laser array.

An elementary electromagnetic beam source can also be referred to as a pixel. If the model comprises frequency-dependent sub-models, an elementary beam can relate to one of these sub-models. For example in the RGB color system for each pixel a red elementary beam, a green elementary beam, and a blue elementary beam can form a composite elementary beam, which can be processed accordingly by the propagation model. The resulting plurality of distorted pixel beams can be superimposed to produce the distorted composite beam.

An elementary beam can also represent a part of an elementary electromagnetic beam source. The elementary electromagnetic beam source can then be represented by a plurality of elementary electromagnetic beams. With a plurality of electromagnetic beams different geometric shapes for an elementary electromagnetic beam source or a pixel can be simulated. An elementary electromagnetic beam source can have a rectangular shape, an elliptical shape, or even a more complex shape. The propagation of the elementary electromagnetic beam can then be calculated individually, by applying the propagation model to each elementary beam of the elementary beam source, i.e. the pixel. Distortions can therefore be determined pixel by pixel and a distorted beam can be produced by superimposing the distorted pixels. For a certain original pattern, only the pixels need to be processed that are active in forming the desired original pattern.

An embodiment of the first aspect relates to a device, wherein a representation of a first pixel beam is processed with a first propagation model and a representation of a second pixel beam is processed by a second propagation model.

The first and the second models can differ in any of the following parameters: Geometric pattern, color distortion, intensity. For example for an elementary beam (pixel beam) that is surrounded by other (active) elementary beams, a less complex propagation model can be used. Because due to the surrounding elementary beams distortions in one of the parameters named above are less detectable than distortions for an elementary beam that is located next to a deactivated elementary beam and/or on the edge of the composite beam. For the two latter elementary beams, a more complex, i.e. more accurate, propagation model can be used. By differentiating the used propagation models in this way computation requirements can be reduced without sacrificing accuracy.

An embodiment of the first aspect relates to a device, configured to determine the representation of the distorted pattern on the propagation model and on representations of the activated pixel beams.

A superposition can be implemented in different ways. For example a superposition of a plurality of simulated distorted elementary beams can be done by fading out the edges of each elementary beam. Additionally or alternatively, the edges of a plurality of elementary beams can be sharply cut such that an overlapping area between adjacent elementary beams is clearly defined and known before computing the distortion of the beams. Of course, a superposition can also be implemented by superimposing distorted elementary beams in full.

An embodiment of the first aspect relates to a device, configured to:
receive a second original pattern of the composite electromagnetic beam; and
determine a representation of the distorted second pattern based on the propagation model and on the second pattern.

The distortion of the electromagnetic beam with the second original pattern can be computed based on the same model that was used to compute the distortion of the electromagnetic beam with the first original pattern. The first and the second patterns can relate to the overall shape of the composite original electromagnetic beam. Additionally or alternatively, the patterns can relate to predefined parts of the original composite electromagnetic beam, in particular if these parts are sampled by a plurality of elementary electromagnetic beams (pixel beams). Two, three or even more different patterns can be simulated during a single simulation, wherein the transition from one pattern to another can be triggered by any events named above, in particular a human input, a change of a traffic situation, etc.

An embodiment of the first aspect relates to a device, further configured to:
present a user interface indicating difference of the representation of the distorted pattern in comparison to a representation of a second distorted pattern determined by a measurement and/or in comparison to a representation of a second distorted pattern determined by a second propagation model.

For example, a user can be presented with a deviation map in order to evaluate the quality of the simulation. In one embodiment of the deviation map, the user can see a first version of the distorted beam pattern, which is a result of processing a full propagation model with a predefined original beam pattern. On the deviation map the user can see a second version of the distorted beam pattern, which is the result of processing a complexity-reduced propagation model with the predefined original beam. Furthermore, the shape and color of the original beam can be shown on the deviation map. By this feedback the user can assess the quality decrease of the simulation in turn for a more efficient, in particular real-time, computation.

An embodiment of the first aspect relates to a device, wherein the propagation model represents an energy distortion of the composite beam.

As defined above a pattern of a composite electromagnetic beam or of an elementary electromagnetic beam can comprise a geometric shape, a color distribution of the electromagnetic beam and/or an intensity distribution of the electromagnetic beam. By using one or more of these parameters to configure the elementary beams (pixel beams) of a representation of a composite beam, complex shapes of an electromagnetic beam can be formed, and their propagation can be modelled. For example an original electromagnetic beam can be represented by elementary beams that are arranged as a rectangle. In order to simulate the beam with its left half side turned off (for example to simulate an adaption of an automotive pixel beam headlight facing opposing traffic), the elementary beams on the left half side of the rectangle are turned off and only the activated beams on the right side are processed by the propagation model.

A second aspect relates to a method, comprising the steps:
providing a representation of an original pattern of a composite electromagnetic beam;
simulating a propagation of the original pattern towards a target based on the representation of the original pattern and based on a first propagation model to provide a representation of a simulated distorted pattern;
based on the representation of the original pattern and based on the representation of the simulated distorted pattern, generating a second propagation model that represents a propagation of the composite beam towards a target.

The first propagation model can in particular be a propagation model that comprises all possible influences on a propagation path that can affect the electromagnetic beam and lead to its distortion. Such a propagation model is also called full propagation model in this disclosure.

In order to provide a propagation model for modelling the propagation of a composite electromagnetic beam through a specific beam system, e.g. through a pixel beam system, the first propagation model can be a model that fully simulates electromagnetic beams propagating through the beam system. Such a simulation can take several days. The second model is based on the first model. This can be a propagation model that can be executed in real-time. If the hardware of the beam system already exists, the first and the second propagation model can be regarded as a digital twin of the beam system.

The method according to the second aspect can comprise features in order to provide a propagation model as described in the context with the first aspect.

The second model can use (or can be established using) a subset of sampling points of the representation of the original pattern, e.g. a 3×3 or a 9×9 subset can be taken of a 42×23 large representation of an original beam pattern, as shown in the Figures below. In particular, the subset of sampling points can be equally distributed over the sampling points of the original pattern. Based on the subset of sampling points that are fitted accurately, the remaining sampling points of a pattern to be simulated are then computed based on an interpolation, for example based on a 2-D polynomial geometric transformation function.

An embodiment of the second aspect relates to a method, wherein the second propagation model has less complexity than the first propagation model.

Less complexity of the second propagation model can in particular comprise that the second model does not take into account the same parameters as the first propagation model. In particular the second model can take into account less parameters than the first model. Additionally or alternatively, the second model can compute the distortions of the electromagnetic beam less accurate than the first model. Furthermore, a less complex second model can be a more differentiated model, e.g. with sub-models for different parts of the beam, but which can be computed faster than the first model if executed on the same hardware. In particular by a less complex second model at least one of the real-time criteria explained above can be met.

A third aspect relates to a method, comprising the steps:
providing an original pattern of a composite electromagnetic beam;
measuring a propagation of the original pattern towards a target to provide a representation of a measured distorted pattern;
based on a representation of the original pattern and based on the representation of the measured distorted pattern, generating a second propagation model that represents a propagation of the composite beam towards a target.

The aspect can also be combined with the second aspect or embodiments of the second aspect. In case a distortion of an original pattern of a composite electromagnetic beam is obtained based on a simulation (second aspect) and based on a measurement (third aspect) the resulting representations of the simulated distorted pattern and of the measured distorted beam can be integrated in order to have a representation of a distorted pattern that comprises simulation and measurement information. Based on the integrated information a second propagation model can be fit more precisely.

In order to provide a propagation model for modelling the propagation of a composite electromagnetic beam through a specific beam system, the hardware of the beam system needs to exist in order that the measurement can be performed.

The method according to the second aspect or third aspect can comprise features in order to provide a propagation model as described in the context with the first aspect.

The working mechanism of the second model according to the second aspect during a simulation can be the same as for the second aspect described above.

In some embodiments, a system for simulation of a composite beam is disclosed. The system can comprise a memory storing executable instructions and one or more processors coupled to the memory to execute the executable instructions. The one or more processors can be configured to generate a representation of the original beam pattern transmitted via a propagation of the composite beam, to invoke a propagation model that represents a distortion for the propagation of the composite beam, and to determine a representation of a distorted beam pattern based on the propagation model and on the representation of the original beam pattern transmitted via the propagation. Optionally, the one or more processors can be configured to present a user interface indicating a difference between the representation of the distorted beam pattern and the representation of the original beam pattern.

The propagation model can be invoked to perform the simulation in real-time.

In some embodiments, the representation of the distorted beam pattern can be determined based on the representation of the original beam pattern.

The representation of the distorted beam pattern can be determined to simulate a transmission of the original beam pattern via a propagation of the beam pattern with the distortion.

In some embodiments, the propagation model can represent a geometric distortion of a shape of the original beam pattern. Alternatively or additionally, the propagation model can represent a distortion of a color of the original beam pattern.

In some embodiments, the propagation model can comprise sub-models. Each of the sub-models can be related to or associated with a different frequency of the composite beam.

In some embodiments, the representation of the original beam pattern, the representation of the distorted beam pattern and/or the propagation model are time variant.

In some embodiments, the propagation of the composite beam is based on a plurality of beam pixels. A shape of the original beam pattern depends on which of the beam pixels are activated (e.g. turned on) and which are deactivated (e.g. turned off). The plurality of beam pixels may be sourced from an electromagnetic wave system. For example, the composite beam can comprise individual beams transmitted from activated beam pixels or source pixels. The representation of the distorted beam pattern can be determined based on a superposition of the individual beams propagated based on the propagation model.

In some embodiments, the propagation model can include a mechanism or function to map a pixel point of the representation of the original beam pattern transmitted via the propagation of the composite beam to a pixel point of the representation of the distorted beam pattern. For example, the mechanism can include a transformation matrix of a shape function which interpolates a mapping solution between the discrete values (e.g. corresponding to distortion of individual pixels).

In some embodiments, a method for generation of a model for simulation of a propagation of electromagnetic beams is disclosed. The method can comprise configuring a beam source for the electromagnetic beams, wherein the beam source corresponds to an original beam pattern on a target according to electromagnetic transmission from the beam source without distortion.

The disclosed method can further comprise simulating a propagation of the electromagnetic beams from the beam source towards the target as a distorted beam pattern; and generating a propagation model to represent the propagation of the electromagnetic beams based on the simulation. The propagation model can comprise sub-models. Each sub-models can be associated with a different frequency of the electromagnetic beams.

In some embodiments, the simulation of the propagation of the electromagnetic beams can comprise sampling a set of pixels from the original beam pattern as a representation of the original beam pattern; and identifying a corresponding set of pixels from the distorted beam pattern as a representation of the distorted beam pattern. The propagation model can be generated based on a distortion relationship between the set of pixels and the corresponding set of pixels.

The number of the sample set of pixels can be determined according to required accuracy of the propagation model to represent the propagation of the electromagnetic beams.

For example, the level of accuracy can vary directly related to the number of sample set of pixels used (or determined, selected). The more the sample pixels can indicate the higher the level of accuracy. The level of complexity (e.g., based on the amount of computation needed to invoke the propagation model may vary inversely related to the associated level of accuracy.

In some embodiments, the beam source can include a plurality of source pixels. The electromagnetic beams can comprise a plurality of beams emitted from the source pixels. Which of the source pixels are activated or deactivated can be determined to configure the beam source for the electromagnetic beams.

Non-transitory computer-readable medium (i.e., physically embodied computer program products) is described that stores instructions, which when executed by one or more data processors of one or more computing systems, can cause at least one data processor to perform operations disclosed herein.

### SHORT DESCRIPTION OF THE FIGURES

Further advantages and features result from the following embodiments, which refer to the figures. The figures describe the embodiments in principle and not to scale. The dimensions of the various features may be enlarged or reduced, in particular to facilitate an understanding of the described technology. For this purpose, it is shown, partly schematized, in:

FIG. 1A two traffic scenarios for a pixel beam headlight;

FIG. 1B a general structure of a pixel beam headlight;

FIG. 2A a representation of an original beam pattern and of a distorted beam pattern based on a simulation according to one embodiment of the present disclosure;

FIG. 2B a working principle of a model and a simulation according to one embodiment of the present disclosure;

FIG. 2C a flow chart for the generation of a reduced-order model for a simulation according to an embodiment of the present disclosure;

FIG. 3 a block diagram illustrating a computer-implemented environment according to an embodiment of the disclosure;

FIG. 4A a block diagram illustrating an exemplary system that includes a standalone computer architecture according to an embodiment of the disclosure;

FIG. 4B a block diagram illustrating an exemplary system that includes a client server architecture according to an embodiment of the disclosure;

FIG. 4C a block diagram illustrating an exemplary hardware for a standalone computer architecture according to an embodiment of the disclosure.

In the following descriptions, identical reference signs refer to identical or at least functionally or structurally similar features.

In the following description reference is made to the accompanying figures which form part of the disclosure and which illustrate specific aspects in which the present disclosure can be understood.

In general, a disclosure of a described method also applies to a corresponding device (or apparatus) for carrying out the method or a corresponding system comprising one or more devices and vice versa. For example, if a specific method step is described, a corresponding device may include a feature to perform the described method step, even if that feature is not explicitly described or represented in the figure. On the other hand, if, for example, a specific device is described on the basis of functional units, a corresponding method may include one or more steps to perform the described functionality, even if such steps are not explicitly described or represented in the figures. Similarly, a system can be provided with corresponding device features or with features to perform a particular method step. The features of the various exemplary aspects and embodiments described above or below may be combined unless expressly stated otherwise.

### DESCRIPTION OF THE FIGURES

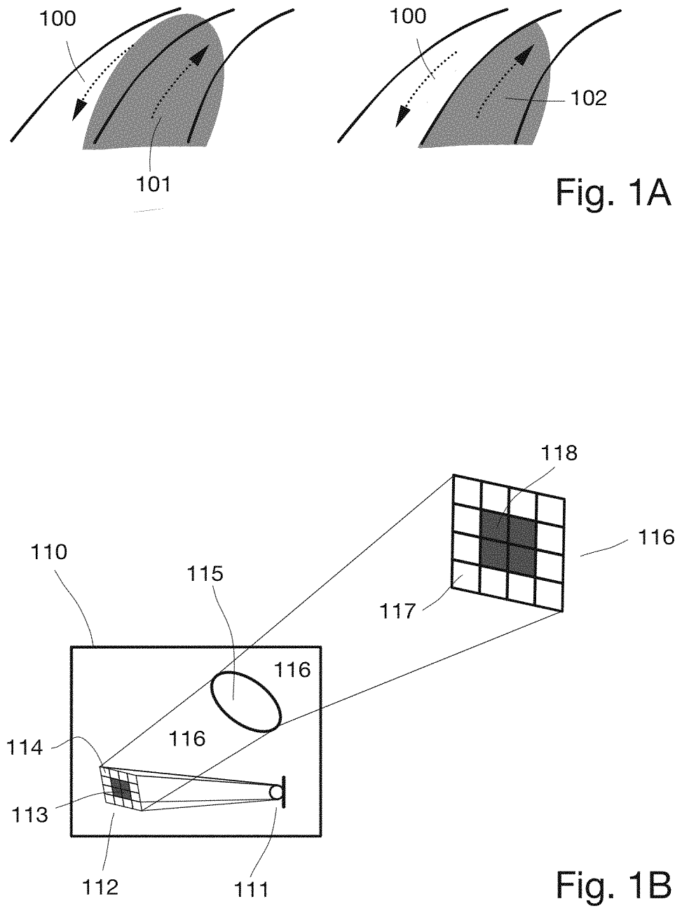

FIG. 1A depicts two scenarios for an adaptive vehicle beam. FIG. 1a shows on the left side and on the right side a road 100 in two different illumination configurations. The road has two lanes, each for one travel direction, as depicted by the arrows. On the left side scenario, the street is fully illuminated. The illuminated area 101 covers both lanes, the right lane of the street and the left lane of the street. On the right side scenario, the illumination by the adaptive beam only covers the right part of the street 102. This would be the case if an oncoming vehicle is detected in order to avoid glaring the driver in the oncoming vehicle. For this kind of illumination, the beam is shaped according to the pathway of the road. This can be done with a so-called pixel beam headlight that can emit a composite beam in different patterns.

FIG. 1B shows a structure of a pixel beam headlight 110. The pixel beam headlight 110 consists of a light source 111 that emits light towards a mirror system 112. The mirror system 112 consists of a plurality of micro-mirrors 113, 114. These micro-mirrors 113, 114 can be controlled individually such that they can reflect the incoming light beam to individual directions or not at all, thereby creating a composite beam with a certain pattern. In the case shown in FIG. 1B, the pixel beam headlight generates a rectangular shaped composite beam 116. In the middle of the composite beam a rectangular region 118 is not illuminated and remains dark. The pixel beam headlight 110 further comprises a lens system 115 that focuses the composite beam towards the road. Accordingly, as perceived from the outside of the pixel beam headlight, the composite beam 116 comprises an illuminated region 117 cast by active micro-mirrors and a non-illuminated region 118 cast by inactive mirrors 113 from the mirror system. A plurality of patterns that differ in geometric shape, intensity and/or color can be generated by such a system.

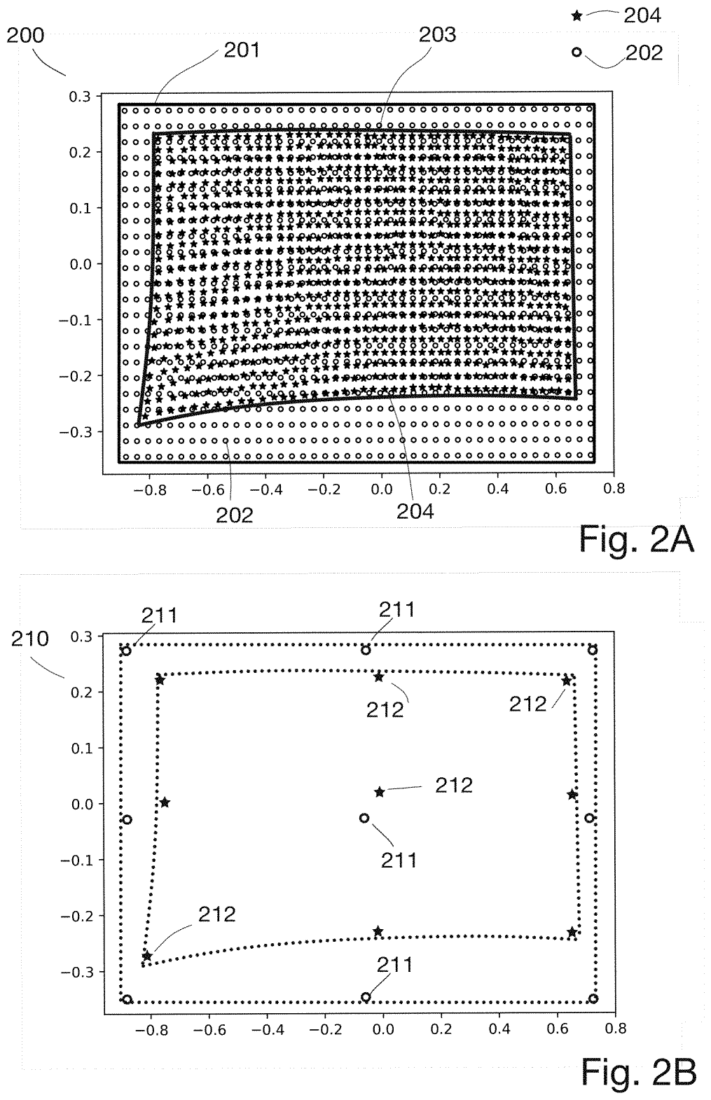

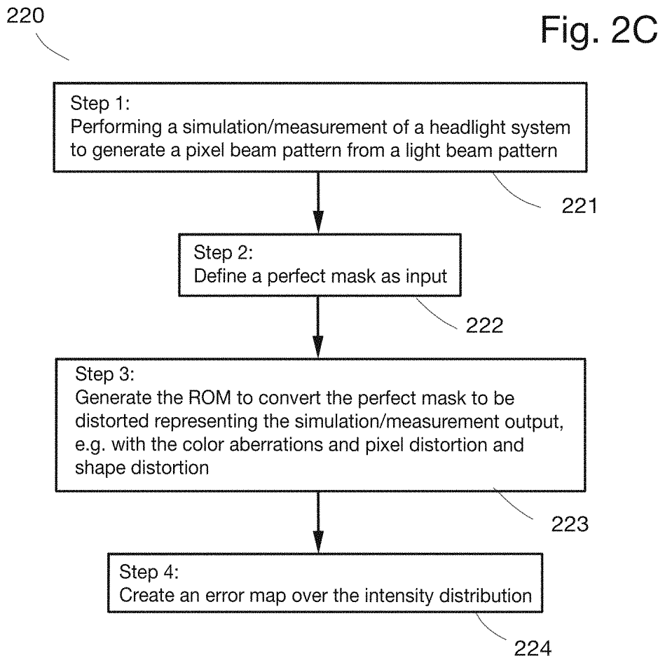

FIG. 2A shows a simulation 200 according to an embodiment of the present disclosure. A representation of a distorted beam pattern 203 is computed based on a representation of an original beam pattern 201 and a propagation model. The representation of the original beam pattern is constructed out of a plurality of sample points that form the rectangle 201. The sample points are depicted by small circles 202. The sample points 202 form a rectangular shape in order to simulate a rectangular shaped original beam pattern from a beam source. As an example, each sample point may correspond to a source pixel or elementary pixel of the beam source, such as an active mirror in FIG. 1. In the same reference coordinates, a representation of a distorted beam pattern is depicted by the sample points 204 that form the area 203. The sample points 204 from the distorted beam pattern 203 are depicted as small asterisks, such that they can be distinguished from the sample points 202 of the original beam pattern 201. In this case, only a geometric distortion of the pattern 203 is depicted from the original pattern 201 to the shape of the distorted beam pattern 203. The distortion is caused by the different subsystems of a pixel beam headlight that affect the propagation of the composite light beam, as depicted in FIG. 1B. The simulation of such a distortion should provide developers of pixel beam headlights an immediate feedback of their simulated system. Therefore, the propagation model that computes the distorted beam pattern 203 from the original beam pattern 201 must be computational fast, in particular predefined real-time conditions have to be fulfilled. Then the different traffic situations depicted in FIG. 1A can be simulated in the same time (real-time) a vehicle driver would experience them if her/his car would be equipped with the simulated light system. The propagation model must be reduced in complexity in order to enable a real-time simulation. A propagation model that takes into account all possible effects the light beam encounters on its propagation path can hardly be simulated in real-time. Therefore, a reduced order propagation model is used as depicted in FIG. 2B.

FIG. 2B depicts a working principle (e.g., for the establishment or construction) of a 3×3 reduced order propagation-model 210 according to one embodiment of the present disclosure. The model can be applied for example to a representation of an original electromagnetic beam (or an original pattern of a composite beam) 201 such as depicted in FIG. 2A. From the representation of an undisturbed original beam pattern 201 nine sample points 202, which are distributed over the whole rectangular shape of the original undisturbed beam, are selected as model sample points 211. Based on the sample points 211, which can for example represent elementary pixels of a pixel beam headlight, a distortion is calculated. This can be done, for example, based on the positions of the distorted sample points or distorted positions of the sample points obtained from a full simulation or a measurement (if the beam system or a prototype thereof already exists). Alternatively, a distortion for the nine sample points can be calculated during the simulation. The calculation can be more or less exact, and e.g., depending on the available hardware and in order to achieve real-time capability of the simulation. This leads to a representation of a disturbed beam 204, based on the nine sample points 212. Each sample point of the original beam pattern 211 is related to (or correspond to) a sample point of the disturbed or distorted beam pattern 212, based on the propagation model. After the sample points of the disturbed beam 212 have been computed or determined based on simulation/measurement, a mapping or transformation relationship or function can be established for the propagation model to compute the distorted positions of the remaining sample points 204. The mapping relationship can be established based on an interpolation of the sample points 212. This could be, for example, done by a 2-D polynomial geometric transformation function. In this way an efficient and fast calculation of the disturbance of all sample points 202 of the original undisturbed beam pattern can be calculated and sample points 204 of the disturbed beam pattern 203 can be computed. The foregoing explanations are related to a geometric distortion of the original beam 201. Computation of chromatic distortions and or distortions of the energy, i.e., intensity, distribution can be computed analogously. In alternative embodiments the sample size of the original beam pattern 201 needs not to be the same as the sample size of the disturbed beam 203. If the sample size of the disturbed beam 203 is smaller than the sample size of the undisturbed beam 201 then fewer sample points have to be interpolated based on the modelled sample points 211. Furthermore, different models may be established based on different sample sizes. For example, a sample size of 3×3 might be sufficient to model a geometric distortion. However, to model an intensity distribution a 9×9-model might be selected. Based on this propagation model, different patterns of the electromagnetic beam can be simulated. This is done by applying the model only to the active sample points that are used to generate a certain pattern. While in FIG. 2A the distortion of a rectangular original pattern is described, other patterns can easily be imagined removing certain sample points that are not used for a specific pattern.

In a further embodiment, elementary sources of a composite light source are modelled individually. These elementary sources can be, for example, a pixel of a pixel beam headlight or a laser of a laser array. Each elementary light source emits an elementary electromagnetic beam. To model the elementary beams, each elementary beam can be represented by a plurality of samples, similar as depicted in FIG. 2A. An original elementary beam as emitted by an elementary light source needs not to have a rectangular shape. Different shapes for the original elementary beam are possible, for example, a circle, an elliptic shape, or a more complex shape. After a representation of an original elementary beam has been generated, a propagation model, similar to the propagation model shown in FIG. 2B, is applied to each representation of each elementary beam. Distorted elementary beams are computed based on the propagation model. The representations of the distorted elementary beams are superimposed in order to arrive at a composite distorted electromagnetic beam. By modelling each elementary electromagnetic beam source (pixel) individually by a plurality of sample points (pixel beams), an accuracy of the distorted composite beam can be increased. This needs not to increase computation time, because the representations of the distorted elementary beams can be calculated concurrently.

FIG. 2D shows a flowchart of a method 220 to generate a reduced order model 210 for a simulation according to an embodiment of the present disclosure. In a first step 221, a simulation of an electromagnetic beam system, for example a headlight system of an automotive vehicle, is performed to generate a pixel beam pattern from a pattern of the light beam that is emitted by the headlight system. This simulation should be as accurate as possible in order to have a reference computation that can form a basis for a reduced order model. Additionally or alternatively, a measurement (or measurement results) can be obtained from measures (e.g. according to physical measures conducted) of the distortions of the light beam of the headlight system transmitted along a predefined propagation path. This propagation path can for example be the headlight system itself. The measurement result can also be taken as a reference on which a reduced order model can be based on. In a second step 222, an input mask is defined. In one embodiment, the input mask may correspond to a light beam pattern projected from a beam source of the light beam to a target location. The beam source may include a set of pixel mirrors to reflect light beams from a light source to the target. This input mask comprises a predefined number of pixels at predefined pixel locations of the light beam pattern. In a third step 223, a reduced order model is generated such that the perfect mask (i.e. the original beam pattern) is converted to a distorted pattern representing the simulation and/or the measurement results. In one embodiment, the reduced order model is generated by fitting it to represent the mapping from the sample points of the perfect mask to the sample points of the distorted beam form according to the prior simulation and/or to the prior measurement. Thereby, geometric distortions, color aberrations, and/or intensity distortions can be taken into account. In a fourth step 224, an error map is generated over the samples such that a deviation from the full simulation and/or the measurement to the reduced order model can be provided to a user.

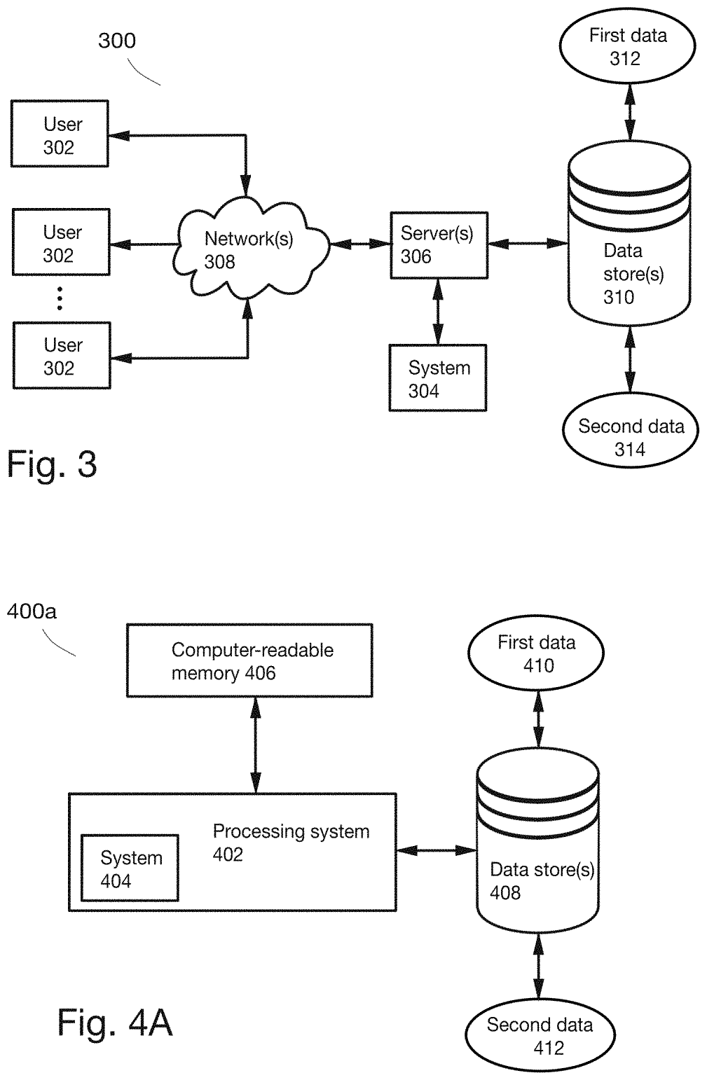

FIG. 3 depicts a computer-implemented environment 300 wherein users 302 can interact with a system 304 hosted on one or more servers 306 through a network 308. The system 304 contains software operations or routines. The users 302 can interact with the system 304 through a number of ways, such as over one or more networks 308. One or more servers 306 accessible through the network(s) 308 can host system 304. The processing system 304 has access to a non-transitory computer-readable memory in addition to one or more data stores 310. The one or more data stores 310 may contain first data 312 as well as second data 314. It should be understood that the system 304 could also be provided on a stand-alone computer for access by a user.

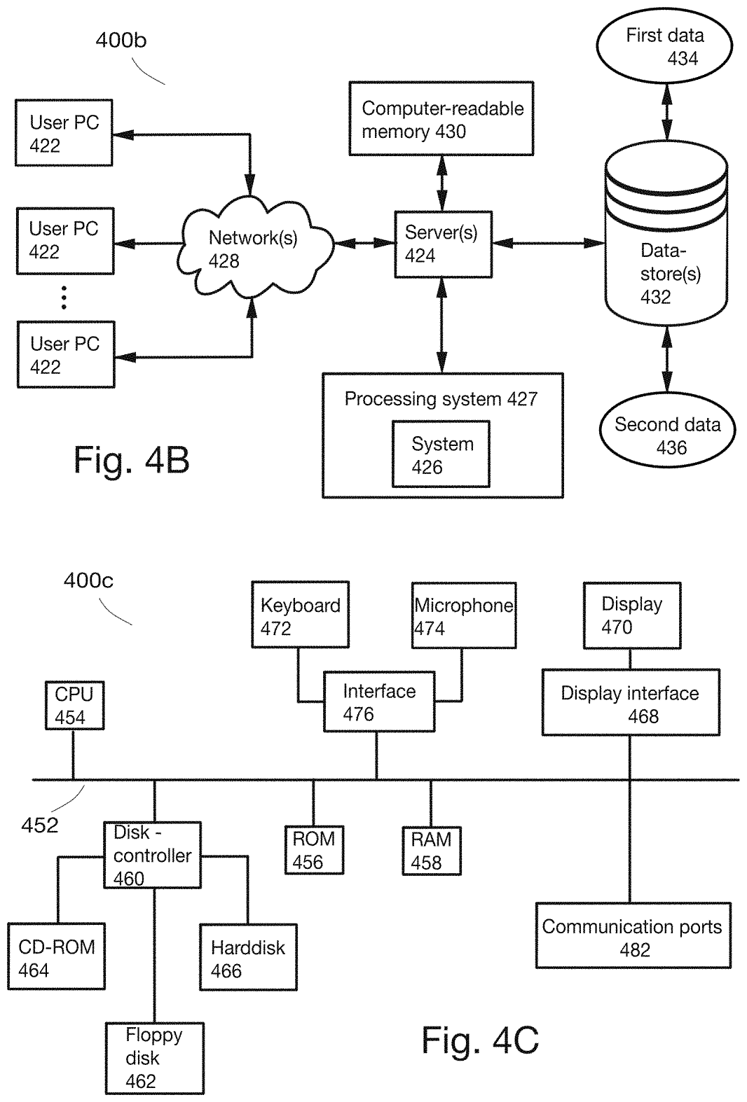

FIGS. 4A, 4B and 4C depict example systems for use in implementing a system. For example, FIG. 4A depicts an exemplary system 400a that includes a standalone computer architecture where a processing system 402 (e.g., one or more computer processors) includes a system 404 being executed on it. The processing system 402 has access to a non-transitory computer-readable memory 406 in addition to one or more data stores 408. The one or more data stores 408 may contain first data 410 as well as second data 412.

FIG. 4B depicts a system 400b that includes a client server architecture. One or more user PCs 422 can access one or more servers 424 running a system 426 on a processing system 427 via one or more networks 428. The one or more servers 424 may access a non-transitory computer readable memory 430 as well as one or more data stores 432. The one or more data stores 432 may contain first data 434 as well as second data 436.

FIG. 4C shows a block diagram of exemplary hardware for a standalone computer architecture 400c, such as the architecture depicted in FIG. 4A, that may be used to contain and/or implement the program instructions of system embodiments of the present disclosure. A bus 452 may serve as the information highway interconnecting the other illustrated components of the hardware. A processing system 454 labeled CPU (central processing unit) (e.g., one or more computer processors), may perform calculations and logic operations required to execute a program. A non-transitory computer-readable storage medium, such as read only memory (ROM) 456 and random-access memory (RAM) 458, may be in communication with the processing system 254 and may contain one or more programming instructions. Optionally, program instructions may be stored on a non-transitory computer-readable storage medium such as a magnetic disk, optical disk, recordable memory device, flash memory, or other physical storage medium. Computer instructions may also be communicated via a communications signal, or a modulated carrier wave, e.g., such that the instructions may then be stored on a non-transitory computer-readable storage medium.

A disk controller 460 boundary layers one or more optional disk drives to the system bus 452. These disk drives may be external or internal floppy disk drives such as 462, external or internal CD-ROM, CD-R, CD-RW or DVD drives such as 464, or external or internal hard drives 466. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 460, the ROM 456 and/or the RAM 458. Preferably, the processor 454 may access each component as required.

A display boundary layer 468 may permit information from the bus 456 to be displayed on a display 470 in audio, graphic, or alphanumeric format. Communication with external devices may optionally occur using various communication ports 482.

In addition to the standard computer-type components, the hardware may also include data input devices, such as a keyboard 472, or other input device 474, such as a microphone, remote control, pointer, mouse, touchscreen and/or joystick. These input devices can be coupled to bus 452 via boundary layer 476.

### LIST OF REFERENCE SIGNS

100 street
101 first light pattern
102 second light pattern
110 pixel beam headlight
111 light source
112 micro-mirror system
113 micro-mirror
114 micro-mirror
115 lens system
116 composite light beam
117 illuminated region of composite light beam
118 dark region of composite light beam
200 representations of original and distorted electromagnetic beam patterns
201 pattern of original electromagnetic beam
202 sample point of original electromagnetic beam pattern
203 pattern of distorted electromagnetic beam
204 sample point of distorted electromagnetic beam pattern
210 propagation model
211 sample point of original electromagnetic beam pattern
212 sample point of disturbed electromagnetic beam pattern
220 method for generating a propagation model
221-224 steps for performing the method 220

It is claimed:

1. A device for simulation of a propagation of a composite electromagnetic beam, configured to:
receive an original pattern for a composite electromagnetic beam;
provide a representation of the original pattern to be transmitted via the composite electromagnetic beam towards a target;
invoke a propagation model that represents the propagation of the electromagnetic beam towards the target; and
determine a representation of a distorted pattern of the composite electromagnetic beam based on the propagation model and on the representation of the original pattern.

2. The device according to claim 1, wherein the propagation model represents a geometric distortion of the original beam.

3. The device according to claim 1, wherein the propagation model represents a chromatic distortion of the original composite beam.

4. The device according to claim 3, wherein the propagation model comprises sub-models and wherein each of the sub-models is related to a different frequency of the original composite beam.

5. The device according to claim 1, wherein the representation of the distorted pattern depends on the representation of the original pattern.

6. The device according to claim 1, wherein a ratio between a sample size of the representation of the original pattern and of the representation of the distorted pattern is:
equal to 1;
smaller than 1; or
greater than 1.

7. The device according to claim 1, wherein the sample size of:
the representation of the original pattern, the representation of the distorted pattern, or the propagation model depends on one or more of the following parameters:
a user input;
a received information;
a wavelength of the original pattern and/or of the distorted pattern;
a temperature in the environment of the composite electromagnetic beam;
the original pattern and/or the distorted pattern itself.

8. The device according to claim 1, wherein the representation of the original pattern, of the distorted pattern and/or the propagation model are time variant.

9. The device according to claim 1, wherein the propagation model enables a simulation of the composite electromagnetic beam in real-time.

10. The device according to claim 1, wherein the composite beam is represented by a plurality of beam pixels and wherein the original pattern depends on which of the beam pixels are activated and which are deactivated.

11. The device according to claim 10, wherein the plurality of pixel beams are sourced from an electromagnetic wave system.

12. The device according to claim 10, wherein a representation of a first pixel beam is processed with a first propagation model and a representation of a second pixel beam is processed by a second propagation model.

13. The device according to claim 10, configured to determine the representation of the distorted pattern on the propagation model and on representations of the activated pixel beams.

14. The device according to claim 1, configured to:
receive a second original pattern of the composite electromagnetic beam; and
determine a representation of the distorted second pattern based on the propagation model and on the second pattern.

15. The device according to claim 1, further configured to:
present a user interface indicating difference of the representation of the distorted pattern in comparison to a representation of a second distorted pattern determined by a measurement and/or in comparison to a representation of a second distorted pattern determined by a second propagation model.

16. The device according to claim 14, wherein the propagation model represents an energy distortion of the composite beam.

17. A method for generation of a model for simulation of a composite electromagnetic beam in a plurality of patterns, comprising the steps:
providing a representation of an original pattern of a composite electromagnetic beam;
simulating a propagation of the original pattern towards a target based on the representation of the original pattern and based on a first propagation model to provide a representation of a simulated distorted pattern;
based on the representation of the original pattern and based on the representation of the simulated distorted pattern, generating a second propagation model that represents a propagation of the composite beam towards a target.

18. The method according to claim 17, wherein the second propagation model has less complexity than the first propagation model.

19. A method for generation of a model for simulation of a composite electromagnetic beam in a plurality of patterns, comprising the steps:
providing an original pattern of a composite electromagnetic beam;
measuring a propagation of the original pattern towards a target to provide a representation of a measured distorted pattern;
based on a representation of the original pattern and based on the representation of the measured distorted pattern, generating a second propagation model that represents a propagation of the composite beam towards a target.
